(19) United States
(12) Patent Application Publication
(10) Pub. No.: US 2006/0060521 A1
(43) Pub. Date: Mar. 23, 2006

(54) Filter device

(75) Inventors: Eberhard Harms, Muppert (DE); Mark Grigo, Soest (DE)

Correspondence Address: RANKIN, HILL, PORTER & CLARK LLP, 4080 ERIE STREET, WILLOUGHBY, OH, 44094-7836, US

(73) Assignee: Utisol Technologies AG, Zug (CH)

(21) Appl. No.: 10/539,139

(22) PCT Filed: Dec. 2, 2003
(86) PCT No.: PCT/CH03/00793

§ 371 Date: Aug. 18, 2005

(30) Foreign Application Priority Data
Dec. 19, 2002 (EP) 02406119.4

(51) Int. Cl. B01D 33/00

(52) U.S. Cl. 210/330

(57) ABSTRACT

The filter device is utilized for the separation of undissolved solid substances from liquids, in particular in the fields of waste water purification and water treatment. The filter device is arranged in a container as capable of rotation (2) and surrounded by the liquid to be filtered. The filter device (1) consists of several filter elements (6) with a space between one another, which are combined to form a rotating filter. The filtrate is drained away at the periphery of the filter elements (6). Solid substances are prevented from adhering to the filter elements (6) during the filtering process. The rotating filter comprises a hollow space in the center and an aeration device (8) is arranged in the hollow space, around which the filter device rotates. The filters are continuously cleaned by the mixture of air and liquid flowing through during the filtering process.

### BACKGROUND OF THE INVENTION

1. Field of the Invention

The invention is related to a filter device, which serves for the separation of undissolved substances from liquids, and which is employed in particular in the fields of waste water purification and water treatment. Especially in biological waste water purification, with these filter devices the activated sludge is separated from the treated waste water.

2. Description of the Related Art

Known filter devices comprise filtering elements with a space between one another, which are combined into filter modules and are arranged in a circular—or polygon-shaped design to be rotatable in a container containing the filter liquid. Serving as filtering elements are either filter plates, which comprise filters on both sides or else porous hollow fibres. The filtrate is suction extracted through conduits at the periphery of the filtering elements. As the filtering time progresses, the solid substances retained from the filter liquid collect on the filter surfaces and as a result impair the filtering process, so that the efficiency of the filter device gets worse.

From DE 195 37 578 it is known how to provide a back-flushing device on the filters for the removal of the sediments impairing the filtration, wherein said device consists of a plurality of suction beams, which lie closely adjacent to the filters on both sides of the filter plate and which extend radially inwards from the outside. The individual suction beams are connected to downpipes and are connected with a suction pump by means of further piping systems. By opening slide valves built into the downpipes, purified liquid from the interior of the filter plates is pressed into the suction beams in order to in this manner free the filter surfaces from the layers of solid substances adhering to them. In the case of an insufficient cleaning, the back-flushing may be increased even more by means of the connected suction pump. During this cleaning process the suctions beams cause mechanical wear on the filters and therefore impair their service life. In addition to the back-flushing device, however, an installation for the intensive cleaning of the filters is provided. In consists of a set of spray pipes extending vertically up to the hollow shaft, the spray nozzles of which are supplied with already purified liquid by a high-pressure pump. Disadvantageous about this is the fact that the purified liquid utilised for the cleaning of the filters flows back into the container enriched with solid material and is thereupon subjected to the filtering process once more, which therefore leads to a reduction of the filtering capacity. The mechanical and the control system complexities for the back-flushing and intensive cleaning installations are not insignificant. The discontinuous cleaning has the consequence, that during the filtering process between the cleaning phases time and again new covering layers of retained solid substances are formed, which have a negative effect on the filtering process.

Known furthermore from EP-A-0.289.674 is a filter device which operates in accordance with the centrifuge principle. For this purpose, a hollow shaft capable of vertical rotation is arranged in a closed container, on which shaft filter elements are attached with a space between one another. The hollow shaft comprises, underneath the container, an inlet valve for supplying the filter liquid, and above the container an inlet valve for supplying the back-flushing medium. Initially, with the inlet valve closed for the back-flushing, filter liquid is introduced into the hollow shaft through the lower inlet valve. As a result of the centrifugal force generated during the rotation, the filter liquid passes through the holes of the hollow shaft and reaches the spaces between adjacent filter elements. The centrifugal force produces an external pressure on the filter plates, so that the filtrate penetrates into the interior space of the filter plates and then by means of piping conduits at the periphery of the plates is drained away and collected in a tank above the closed container, from which it is able to drain away. Here too, covering layers are formed during the filtering process on the filtering surfaces, which covering layers impair the filtering process as the filtering time progresses. For this reason, a regular back-flushing operation is necessary. The supply of filter liquid is interrupted for the time of the back-flushing and through the inlet valve for the back-flushing operation a back-flushing medium is introduced into the hollow shaft under high pressure, wherein said medium consists either of clear filtrate, air or gas and wherein it flows out between the filter plates adjacent to one another through the holes in the hollow shaft and thus removes the covering layers on the filtering surfaces, which impair the filtration. The back-flushing calls for relatively elaborate technical measures. Apart from this, the efficiency of the filtering process becomes worse.

According to EP 1 149619, a filter device is known, which serves for the purpose of purification of contaminated liquids and in particular of waste water and which is submerged capable of rotation in a container with filter liquid. It comprises several plate-shaped filter elements with spaces between one another, which are combined into circular- or polygon-shaped filter modules and which form a hollow space in the centre, which is closed on one side towards the container and which on the other side is connected with the container through a suction aperture, wherein the hollow space is brought into interaction with a flow-producing element in such a manner, that through the suction aperture in the filter liquid a flow is produced between the filter elements with spaces between one another, wherein said flow prevents the adhesion of the solid substances filtered out of the filter liquid to the filters. Serving as flow-producing elements are bucket wheels, which are either directly coupled to the rotary movement of the filter device or else are separately driven. With a coupled drive, very high speeds of rotation of the filter device are necessary, which may lead to premature wear of the materials. The manufacturing requirements as well as the energy consumption are still relatively high.

From FR 799 391 a filter device is known, in the case of which filter plates are arranged on a common horizontal shaft and at an angle to said shaft. The shaft is hollow and is utilised for the suction extraction of permeate from the filter plates. Underneath the rotating filter plates at the bottom of a filtering tank means for the introduction of gas for the purpose of cleaning the filter plates are arranged.

### SUMMARY OF THE INVENTION

The invention is based of the objective of creating a filter device for the separation of undissolved substances from liquids, which, while avoiding the disadvantages of prior art, makes possible an automatic, free of wear cleaning of the filtering surfaces of filter elements.

In accordance with the invention, the objective is achieved by the solution, that the filter device with several filter elements for the separation of undissolved substances from liquids, in particular in the fields of waste water purification and water treatment, for the introduction into a container containing the unpurified liquid, comprises filter elements rotatable around a horizontal axis and a gassing installation, in preference an aerating device. This device, for the purpose of forming a mixture of gas and liquid, is capable of being impinged on with compressed gas and is arranged in such a manner that in the liquid a flow of the mixture of gas and liquid is produced between the filter elements, which makes an adhesion of solid substances to the filter elements more difficult. To this effect, the filter elements are arranged to be rotatable around the gassing installation.

The filter elements therefore rotate around a zone in which the gassing installation is arranged. As a result of this, individual segments of the filter elements are cleaned one after the other. As a result of the central arrangement of the gassing installation relative to the filter elements rotating around the horizontal axis, an only half as high counter-pressure has to be overcome for the introduction of the gas, this in comparison with an aeration, which is arranged underneath the filter elements. With this, the energy consumption of the device is significantly reduced. This procedure makes a cleaning during the filtering process possible. The device according to the invention is easy to manufacture and consumes little energy and in addition there are no elaborate requirements of the control system. If the filter device comprises rotating filter elements, the cleaning also works with a low speed of rotation. It may also be designed in such a manner, that a movement of the filter elements relative to the container is not necessary at all.

The gassing—in the following for the simplification of the description only the term “aeration” will be used, wherein, however, another manner of gassing, for example, with nitrogen gas or with another gas from a pressure reservoir is included—takes place, for example, by the introduction of compressed gas into a hollow body, which is either porous or provided with holes and which in preference is of tubular construction. The hollow body or the hollow bodies preferably extends/extend over the whole width of the zone, in which filter elements are present. The hollow body/the hollow bodies may be closed at the ends and may be connected with a chamber or a hollow shaft through hollow connecting pieces.

In accordance with one embodiment of the invention, the filter elements at the periphery are designed as circular or polygon-shaped and, for example, each formed by several filter modules. In a hollow space formed in the interior, e.g., at the centre, around the horizontal axis, the aeration device is accommodated. In a first preferred embodiment of the invention, the hollow space is connected with the container at least on one side through apertures. In a second preferred embodiment of the invention the hollow space is closed, or separated from the container on both sides in the zone of the axis.

By the compressed air flowing out—and also by the suction extraction of filtrate from the filters—through the at least one aperture of the hollow space, respectively, between the filter plates located underneath the hollow space, filter liquid is sucked in. The mixture of air and liquid produced by this flows upwards between the filter elements having a space between one another. Through the rotational movement a sequential cleaning of the filter modules takes place. As a result of this, an adhesion of solid substances to the filter elements is rendered more difficult, or prevented, as the case may be. As a result of the sequential cleaning the energy requirement is minimised, because through the rotational process always only a part of the filtering surface formed by the filter modules is conducted past the flow field of the mixture of air and liquid.

According to a special embodiment, in the first preferred embodiment of the invention in the upper half of the at least one aperture of the hollow space on the hollow shaft spoilers—for example, of semicircular shape—are attached, in order to enhance the effect of the compressed air flow on the filter liquid.

### BRIEF DESCRIPTION OF THE DRAWINGS

The invention shall be explained in more detail in the following on the basis of an example of an embodiment. The accompanying drawings illustrate:

FIG. 1: a schematic representation of the filter device in accordance with a first embodiment of the invention;

FIG. 2: a section through the line I-I in accordance with FIG. 1;

FIG. 3: a section through the line II-II in accordance with FIG. 2;

FIG. 4: a section through the aeration device through the line III-III in accordance with FIG. 1;

FIG. 5: the arrangement of a semicircular spoiler on the hollow shaft as a detail in accordance with the direction of the arrow A (FIG. 1);

FIG. 6: a schematic representation of the filter device in accordance with a further embodiment of the invention;

FIG. 7: a section through the line IV-IV in accordance with FIG. 6;

FIG. 8: a section through the line V-V in accordance with FIG. 7.

### DETAILED DESCRIPTION OF THE INVENTION

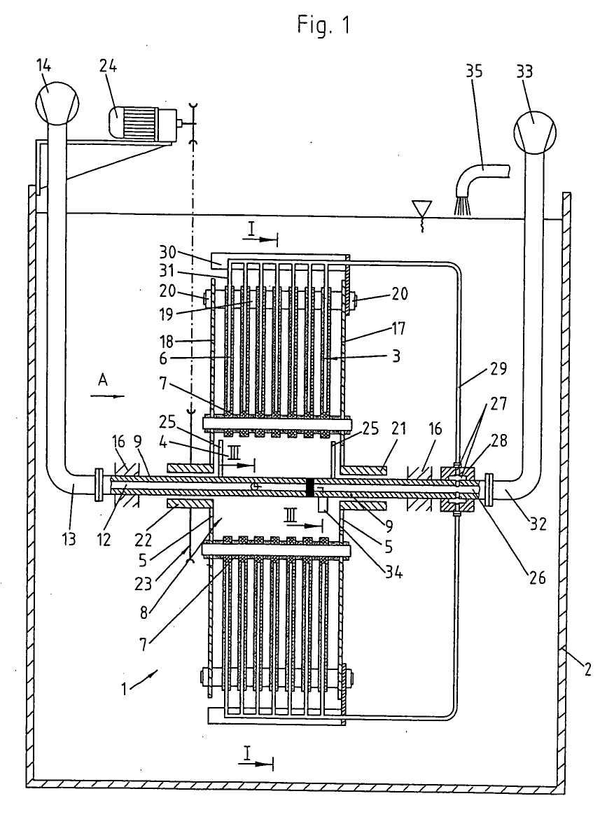

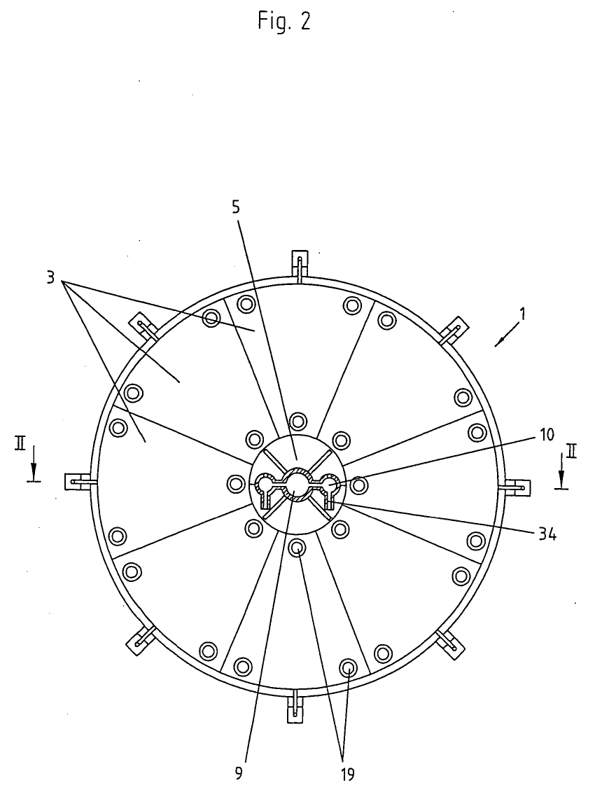

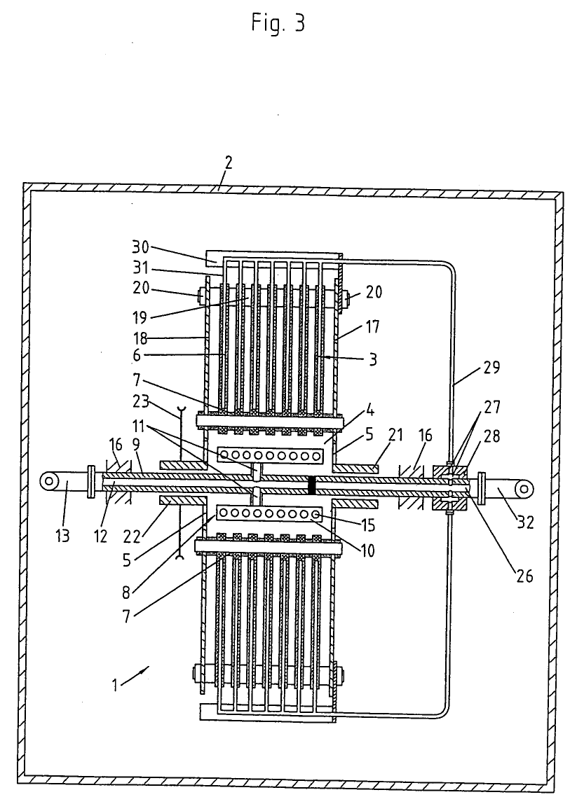

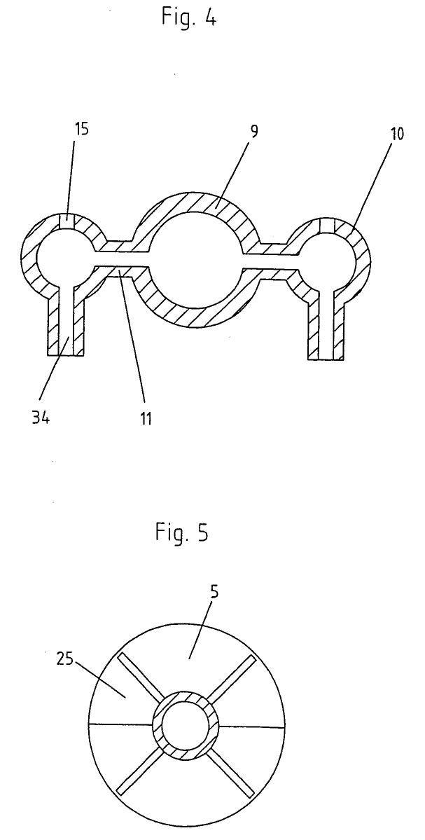

The FIGS. 1 to 3 illustrate a first preferred embodiment of the invention: The filter device 1 is accommodated rotatably in a container 2 filled with filter liquid. It comprises several filter modules 3. The individual filter modules 3 combine to form plate-like, at the periphery e.g. circular or polygon-shaped filter elements 6. The individual filter elements 6 are joined together with a space between them of, e.g., 4 to 8 mm. The filter modules 3 combined to form the filter elements 6 consist, for example, of several essentially parallel filter plates (not illustrated), which as such are already known. The filtrate is drained off through the filter plates, which are provided with filters on both sides. By means of spacer plates 7, it is possible to adjust the space between the filter elements 6. In the hollow space 4, an aeration device 8 is arranged horizontally. The aeration device 8 consists of hollow bodies 10 arranged parallel to a hollow shaft 9, which extend over the whole width, over which filter elements 6 are present, wherein said hollow bodies are closed at the ends and are connected with a chamber 12 of the hollow shaft 9 through hollow connecting pieces 11, which chamber in turn is connected with a compressed air generator 14 through a piping conduit 13. The hollow bodies may be piping conduits, which for the purpose of the delivery of the compressed air either consist of porous material or else are provided with holes 15. The hollow shaft 9 connected with the aeration device 8 is stationarily supported in bearings 16. The zone of the filter elements 6 is delimited on both sides by bearing plates 17, 18, the filter elements 6 are attached to these by means of stay bars 19 and nuts 20. The bearing plates 17, 18 are supported capable of rotation on the hollow shaft 9 in bearings 21, 22. Through the bearing 22, the filter device 1 is connected with a chain drive 23, which is driven by a motor 24 (FIG. 1). In the upper half of the hollow space 4 the two apertures 5 are covered by spoilers 25, which are attached to the hollow shaft 9. As a result of this, the flow effect on the filter liquid is increased (FIGS. 1 and 5). The hollow shaft 9 apart from the chamber 12 comprises a second chamber 26. From said chamber channels 27 radially extend through the hollow shaft 9 through a sliding ring 28, which is connected with the pipes 29, which lead into channel strips 30 and which are attached to the bearing plate 17. From the channel strips 30, piping conduits 31 branch off to the individual filter modules 3. The second chamber 26 of the hollow shaft 9 is connected with a vacuum pump 33 through a piping conduit 32. The hollow bodies 10 are provided with open socket pieces 34 directed downwards, this in order to prevent filtrate sediments. 5.

The mode of operation is now the following: While the filter device 1 rotates around the aeration device 8, by means of the vacuum pump 33 filtrate is aspirated from the container 2, which then penetrates through the filters of the filter elements 6 and is thereupon drained away through pipes 31, channel strips 30, pipes 29, the radially disposed channels 27 of the sliding ring 28 and the hollow shaft 9, the second chamber 26 as well as the piping conduit 32. From the hollow bodies 10 the filtrate is able to escape into the hollow space 4 through the socket pieces 34, in order to prevent a sedimentation of solid substances from the filtrate. Through an inlet 35 the level of the filter liquid in the container 2 is maintained approximately constant. Simultaneously, from the compressed air generator 14 through the aeration device 8 compressed air is blown into the hollow space 4. The compressed air blown in flows upwards. A mixture of air and liquid is produced, which flows through the filter elements adjacent to one another and, if so required, between the filter plates and with this prevents that solid substances can be deposited on the filters. As a result of the rotational movement of the filter elements 6, a sequential cleaning is achieved, as a result of which the energy requirement, because of the small surface area subject to the flow, is low. Apart from this, depending on the air flowing upwards, an additional suction effect may be produced at the apertures 5, as a result of which filter liquid is sucked out of the container 2 through the two apertures 5.

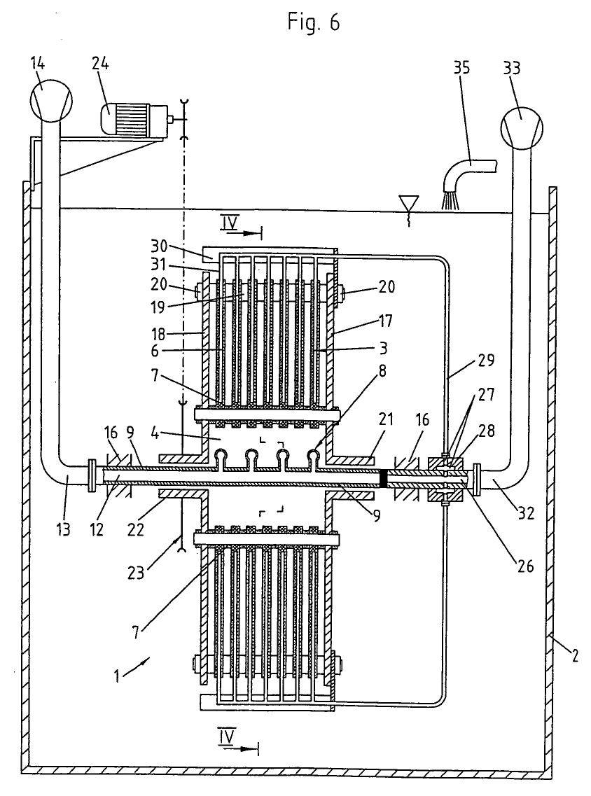

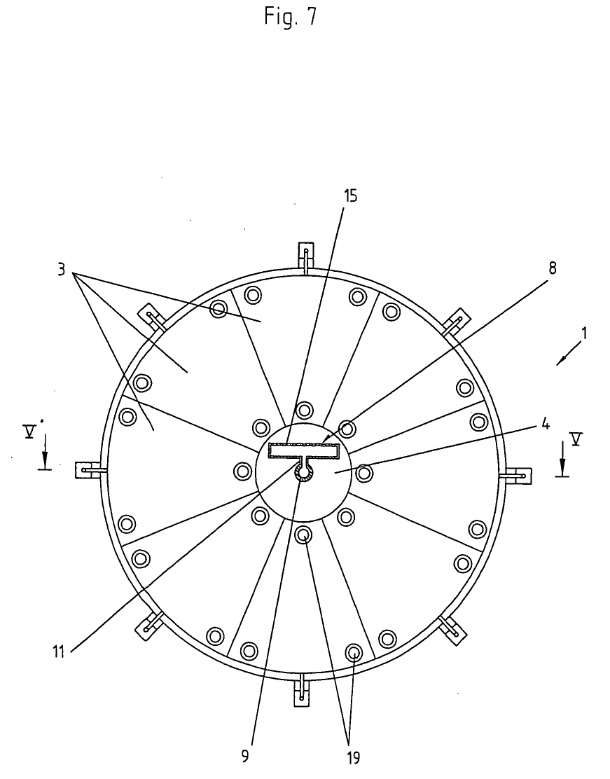

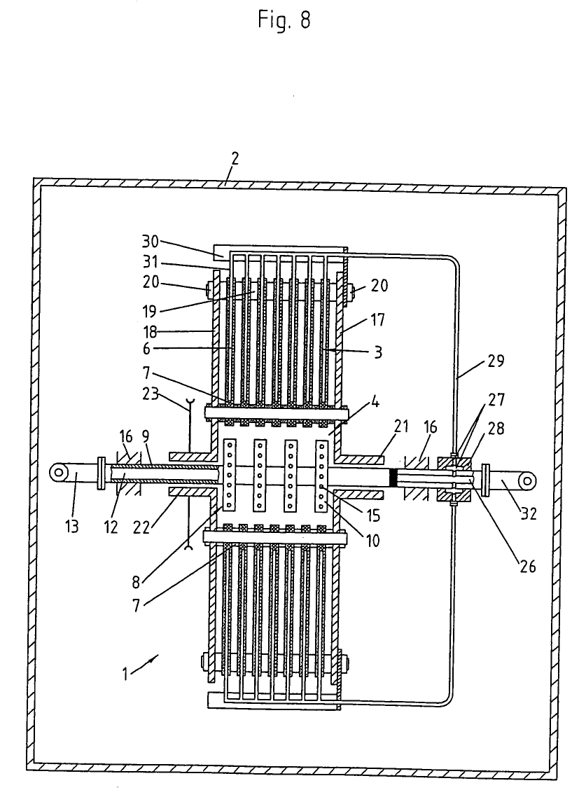

The FIGS. 6 to 8 illustrate a second preferred embodiment of the invention: In contrast to the first embodiment, the hollow space 4 around the shaft is not connected with the container 2 through apertures 5 in the zone of the axis, but rather is closed relative to the container 2 in the zone of the axis. The bearing plates 17, 18 for this purpose extend right up to the bearings 21, 22, and this along the complete circumference of the bearings 21, 22. As a result of this, they form separating walls between the container 2 and the hollow space 4 on both sides of the aeration installation 8. The aeration installation 8 comprises several pieces of pipe, respectively, hollow bodies 10 with holes 15. The hollow bodies 10 are essentially arranged vertically to the hollow shaft 9 and are connected with this hollow shaft 9 for the purpose of providing an air supply through connecting pieces 11. In principle, also the aeration device 8 in accordance with the first embodiment of the invention is capable of being operated with the closed hollow space and vice versa.

On the basis of the closed side walls, the second embodiment with respect to the cleaning operation works as follows: By the aeration installation 8, as in the case of the first embodiment, between the filter plates a mixture of air and liquid flowing upwards is produced. The liquid flowing after this mixture it is also sucked up between the filter plates by a sector of the filter plates located underneath the axis, respectively, of the aeration installation 8. This following liquid therefore is introduced from below along the whole length of the rotating filter. This is an advantage in the case of filters which are long in the direction of the axis.

In principle it is also possible to design the hollow space 4 and the gassing installation 8 arranged within it to be smaller. For example, it is possible to bring the filter elements 6 close to the hollow shaft 9, and the hollow shaft may also solely comprise bores or short socket pieces as apertures for the gas outlet.

The invention is also capable of being utilised in filter devices for the separation of undissolved substances from liquids, which comprise filter elements constructed and arranged differently than those described above, out of modules made by a combination of filter elements with several filter plates.

1. A filter device (1) for the separation of undissolved solid substances from liquids, in particular in the fields of waste water purification and water treatment, with several filter elements (6), for the introduction into a container (2) containing the unpurified liquid, wherein through the individual filter elements (6) a filtrate is capable of being drained away, the filter elements are arranged so as to be capable of rotating around a horizontal axis, and the filter elements (6) are designed and arranged in such a manner, that they form a hollow space (4) in the center, and wherein the filter device (1) comprises a gassing installation (8), which is stationarily arranged in the hollow space (4) and which for the formation of a mixture of gas and liquid is capable of being impinged with compressed gas and which is arranged in such a manner, that in the liquid a flow of a mixture of gas and liquid is capable of being produced at the filter elements (6), which renders an adhesion of solid substances to the filter elements (6) more difficult, and the filter elements (6) are arranged to be rotatable around the gassing installation (8), wherein the gassing installation (8) comprises either at least one elongated hollow body (10) arranged parallel to a hollow shaft (9), which is closed at the ends on both sides, or comprises at lest one elongated hollow body (10) arranged horizontally as well as orthogonally to a hollow shaft (9), and the at least one hollow body (10) is connected with a chamber (12) of the hollow shaft (9) through connecting pieces (11), wherein the chamber (12) is connected with a compressed gas generator (14).

2. (canceled)

3. The filter device according to claim 1, wherein the hollow space (4) is connected with the container (2) through apertures (5).

4. The filter device according to claim 1, wherein the hollow space (4) is closed relative to the container (2).

5. (canceled)

6. (canceled)

7. The filter device according to claim 1, wherein the filter elements (6) are rotatably supported by bearings (21, 22) on the hollow shaft (9) connected with the gassing installation (8).

8. The filter device according to claim 1, wherein the hollow shaft (9) comprises a second chamber (26), which is connected with a vacuum pump (33) for draining away the filtrate.

9. The filter device according to claim 8, wherein the chamber (26) for the draining away of the filtrate is provided with channels (27), which extend radially to the chamber (26) through the hollow shaft (9) and through a sliding ring (28) arranged as rotatable on the hollow shaft (9), which is connected with piping conduits (29), which are connected with the filter elements (6).

10. The filter device according to claim 1, wherein the at least one hollow body (10) of the gassing installation (8), for the purpose of preventing sediments from the filter liquid, is provided with open socket pieces (34) directed downwards.

11. The filter device according to claim 1, wherein in the upper zone of the apertures (5) semicircular spoilers are attached, in order to increase the effect of the flow of compressed air on the filter liquid.

12. The filter device according to claim 1, wherein the at least one hollow body (10), in preference, is designed as pipe-shaped and in order to allow the compressed gas to escape is comprised of a porous material or else is provided with holes (15).
